(19) United States
(12) Patent Application Publication
(10) Pub. No.: US 2012/0324582 A1
(43) Pub. Date: Dec. 20, 2012

(54) SERVICE SYSTEM THAT DIAGNOSES THE VULNERABILITY OF A WEB SERVICE IN REAL TIME MODE AND PROVIDES THE RESULT INFORMATION THEREOF

(76) Inventor: Hee Jung Park, Seoul (KR)

(21) Appl. No.: 13/512,044

(22) PCT Filed: Jan. 18, 2011
(86) PCT No.: PCT/KR2011/000361

§ 371 Date: Aug. 24, 2012

(30) Foreign Application Priority Data
Feb. 19, 2010 (KR) 10-2010-0015057

(51) Int. Cl. G06F 21/00

(52) U.S. Cl. 726/25

(57) ABSTRACT

A service system that diagnoses the vulnerability of a web service in real time mode and provides the result information thereof according to the present invention receives the input of a user web service address through the web service, automatically visits the corresponding web service to perform the real-time analysis on a web page and check if the web page has a vulnerability, and transmits the result information to a user PC. The service system can provide an intuitive service by displaying the discovery of the vulnerability, the procedure and an external URL linked to the web page are displayed on the user screen; find out the possibility of an outflow of the information contained in the URL by checking, on the basis of the web page analysis, whether a symbol or reserved word (system command) among the factors has been filtered; and display the classification of vulnerabilities of respective DBs by analyzing the result to be sent to an object system before being displayed on the web page. Further, the service system retains the data on the vulnerability of each DB in a program as a resource to compare the data with the result received from the web service and identify a problem if present; includes a script analysis section; and conducts an analysis on links according to an analyzed portion of an index page sot that the user can see the checking procedure via a taken place link in real time mode as well as the diagnosis progress that has been proceeded up to that point whenever desired and find links being connected. Moreover, when the service system analyzes the web page, the user can easily check an external link section and detect any external domain, if present, which spreads a malicious code in the web service. In addition, the service system allows the user to check over the internet the items for the service diagnosis selected by the user and the diagnosis result, and thus to personally see the problems and solutions therefor.

### TECHNICAL FIELD

The present invention relates to a service system for diagnosing vulnerability of a web service in real-time and providing information on a result thereof. The service system can receive an input of a user's web service address through the web service, automatically visit a corresponding web service to perform a real-time analysis on a web page and check if the web page has vulnerability of interest, and transmit information on the checked result to a user PC. The service system can also provide an intuitive service by displaying discovery and progress of the vulnerability, and an external URL linked in the web page on the user screen. In addition, the service system can determine a possibility of leakage of information contained in the URL by checking whether or not a special symbol or reserved word (e.g., system command) among arguments is filtered by analyzing the web page, can analyze a result sent from a target system and display a result of classifying vulnerability of each DB before being displayed on the web page, and can confirm existence of a problem by storing data on the vulnerability of each DB in a program in the form of data and comparing the data with the result received from the web service. A user may confirm the process of finding a link of a web page and confirming a problem and the process of performing an analysis by himself or herself online. Besides, the service system includes a script analysis section and can confirm the process of examining each link in real-time by conducting analysis on the link based on a portion where an index page is analyzed. Moreover, the service system may confirm a result of diagnosis progressed up to the present at any time if necessary during the diagnosis and confirm a connected list. The service system may confirm a problem related with a user by directly facing a URL that causes a problem in a user's browser, arguments (i.e., arguments that cause a problem) contained in the URL, and a type of problem. Further, the service system may confirm an external link section when analyzing a web page and easily detect an external domain, if present, which distributes a malicious code in the web service. The service system may confirm a service diagnosis item selected by the user online, an item for confirming the procedure of progress in real-time, and a diagnosis result online. In addition, the service system may confirm a problem and a solution to the problem.

### BACKGROUND ART

Owing to advancement in communication techniques and generalization of the Internet, a large number of works performed off-line are performed online. In order to perform a large amount of conventional off-line works online, each of service providers provides a user with a ‘web application’ which functions as a kind of channel. However, among various items of information inputted and outputted through the web application, there is a plenty of information that may directly and financially damage users, such as financial information of a user, if it is leaked to the outside and maliciously used.

Accordingly, the so-called hackers tend to focus their attack target on web applications which are the unique channel of information in order to access the information, and web applications that do not consider securities are inevitably easily crashed by the attacks.

The document ‘A Guide to Building Secure Web Application’ announced in the Open Web Application Security Project (OWASP) exemplifies SQL Injection, Cook Spoofing and Injection, File Upload and Download, Parameter Manipulation, Cross Site scripting (XSS), and the like as the types of attacks on the web applications, and it is determined that SQL Injection and XSS are the most dangerous among the types of attacks on the web applications.

SQL Injection is a type of attack injecting a malicious command. The SQL Injection refers to an attacking technique in which disallowed information is acquired through falsification of a SQL query by inputting an abnormal SQL command through a website user authentication window or a URL direct input window. If such an SQL injection occurs, damages such as abnormal authentication of a user, unconstrained retrieval of data stored in a database, manipulation of a system using a system command of the database or the like may occur.

XSS refers to an attacking technique in which a malicious script is inserted in a dynamically created web page and user's data is snatched by executing the inserted script when a user accesses the web page. If such an XSS occurs, damages such as leakage of user's cookie information, and execution of a malicious code in a user terminal or the like may be caused.

Intrusion of an attack code into each argument contained in the URL should be blocked in order to prevent various types of attacks on web applications, and whether or not an argument is vulnerable to each type of attack should be determined in advance for all the arguments contained in each URL in order to fundamentally block intrusion of an attack code into each of the arguments.

However, although a large number of arguments are identical among the arguments contained in the URL, a conventional method of determining vulnerability of each URL argument determines vulnerability of all the arguments contained in the URL. Therefore, there are caused problems in that too much time is required to determine the vulnerability, and vulnerability determination may be redundantly performed even on URLs or arguments for which vulnerability determination has been already completed. Particularly, such problems are getting further serious in a web site of a large scale such as a portal web site.

### DISCLOSURE OF INVENTION

### Technical Problem

Accordingly, the present invention has been made to solve the above-mentioned problems associated with the prior art, and it is an object of the present invention to provide a service system for diagnosing vulnerability of a web service in real-time and providing information on a result thereof, in which the service system can receive an input of a user's web service address through the web service, automatically visit a corresponding web service to perform a real-time analysis on a web page, and check if the web page has vulnerability of interest, and transmit result information to a user PC.

Another object of the present invention is to provide a service system for diagnosing vulnerability of a web service in real-time and providing information on a result thereof, in which the service system can provide an intuitive service by displaying discovery and progress of the vulnerability, and an external URL linked in the web page on the user screen.

Still another object of the present invention is to provide a service system for diagnosing vulnerability of a web service in real-time and providing information on a result thereof, in which the service system can determine a possibility of leakage of information contained in the URL by checking whether or not a special symbol or reserved word (e.g., a system command) among arguments is filtered by analyzing the web page.

Yet another object of the present invention is to provide a service system for diagnosing vulnerability of a web service in real-time and providing information on a result thereof, in which the service system can analyze a result sent from a target system and display a result of classifying vulnerability of each DB before being displayed on the web page, and confirm existence of a problem by storing data on the vulnerability of each DB in a program in the form of data and comparing the data with the result received from the web service.

A further object of the present invention is to provide a service system for diagnosing vulnerability of a web service real-time and providing information on a result thereof, in which a user can confirm the process of finding a link of a web page and confirming a problem and the process of performing an analysis by himself or herself online.

A still further object of the present invention is to provide a service system for diagnosing vulnerability of a web service in real-time and providing information on a result thereof, in which the service system includes a script analysis section and can confirm the process of examining each link in real-time by conducting analysis on the link based on a portion where an index page is analyzed, and in which the service system can confirm a result of diagnosis progressed up to the present at any time if necessary during the diagnosis and confirm a connected list.

A yet further object of the present invention is to provide a service system for diagnosing vulnerability of a web service in real-time and providing information on a result thereof, in which the service system can confirm a problem related with a user by directly facing a URL that causes a problem in a user's browser, arguments (i.e., arguments that cause a problem) contained in the URL, and a type of problem.

Another still further object of the present invention is to provide a service system for diagnosing vulnerability of a web service in real-time and providing information on a result thereof, in which the service system can confirm an external link section when analyzing a web page and easily detect an external domain, if present, which distributes a malicious code in the web service.

Another yet further object of the present invention is to provide a service system for diagnosing vulnerability of a web service in real-time and providing information on a result thereof, in which the service system can confirm a service diagnosis item selected by the user online, an item for confirming the procedure of progress in real-time, and a diagnosis result online, and even confirm a problem and a solution to the problem.

### TECHNICAL SOLUTION

To achieve the above objects, according to a preferred embodiment of the present invention, there is provided a service system for diagnosing vulnerability of a web service in real-time and providing information on a result thereof, the system including: a user terminal having a function of allowing a user to initially input or select a URL or a start page of a web service managed by the user through the user terminal and diagnose the web service through a vulnerability determination system, the user terminal configured to receive information on a result of vulnerability, information on a solution to a problem of an external link where a malicious code is identified, and statistical information from the vulnerability determination system; the vulnerability determination system configured to receive the URL or the start page of the web service from the user terminal, extract a URL link, scan a web page, transmit the scanned web page to a target system, receive an identified problem from the target system, analyze the web page, store an analysis result in a vulnerability database, and transmitting information on a diagnosis result and information on a solution to the problem to the user terminal; and the target system configured to read and diagnose the web page received from the vulnerability determination system, and identify and transmit vulnerability and link problems to the vulnerability determination system.

In the present invention, the vulnerability determination system includes: a vulnerability scanner configured to receive the URL or the start page of the web service from the user terminal, scan the URL or the start page of the web service and transmit the scanned URL or start page to the target system; a URL link extraction unit configured to receive the URL of the web service from the user terminal and extract the URL link; a web page analysis unit configured to receive a diagnosis result from the target system and analyze the diagnosis result after the vulnerability scanner transmits the web page to the target system; a vulnerability database configured to store a vulnerability problem from the result analyzed by the web page analysis unit; a vulnerability solution link unit configured to store information on a solution to the vulnerability problem and solve the vulnerability appropriately if the problem occurs; and a diagnosis result transfer unit configured to transmit the vulnerability problem and the solution information received from the target system to the user terminal.

In the present invention, the URL link extraction unit confirms a link by examining a URL link section used by HTML, i.e., arguments such as src, img, href, li, option, and form; determining an address of a character string having an extension used by a web service in the source of a web page, i.e., examining http or https with characters; or reading all the values of characters surrounded by quotation marks “and ’, reading values of character strings having an address format of a web page, and determining whether or not the character string is an address.

In the present invention, the methods in which the URL link extraction unit confirms a link can be applied to an xml file, a js file or a swf (flash) file that can be regarded as a separate file, but not a web page, in the same manner.

In the present invention, a file is downloaded and connected to the web page analysis unit in real-time in order to analyze a flash file in the web page analysis unit, and the web page analysis unit confirms whether or not the file is a flash file, analyzes the internal file structure, identifies a section written in an Action Script, identifies an internal or external link existing in the corresponding section, and stores the link as an address to visit and analyze in next turn.

In the present invention, the target system includes an argument separation unit configured to confirm whether or not there is a fundamental problem in vulnerability that can be analyzed in real-time in order to promptly diagnose the vulnerability existing in a web page, a transfer unit configured to input additional characters in each argument and transferring the argument to a web service that is to be diagnosed, and a determination unit configured to determine a result returned from the web service.

### Advantageous Effects

The service system for diagnosing vulnerability of a web service in real-time and providing information on a result thereof according to the present invention has the following effects.

First, the service system can receive an input of a user's web service address through the web service, automatically visit a corresponding web service to perform a real-time analysis on a web page, and check if the web page has vulnerability of interest, and transmit result information to a user PC.

Second, the service system can provide an intuitive service by displaying discovery and progress of the vulnerability, and an external URL linked in the web page on the user screen.

Third, the service system can determine a possibility of leakage of information contained in the URL by checking whether or not a special symbol or reserved word (e.g., a system command) among arguments is filtered by analyzing the web page.

Fourth, the service system can analyze a result sent from a target system and display a result of classifying vulnerability of each DB before being displayed on the web page, and confirm existence of a problem by storing data on the vulnerability of each DB in a program in the form of data and comparing the data with the result received from the web service.

Fifth, a user can confirm the process of finding a link of a web page and confirming a problem and the process of performing an analysis by himself or herself online.

Sixth, the service system includes a script analysis section and can confirm the process of examining each link in real-time by conducting analysis on the link based on a portion where an index page is analyzed, and in which the service system can confirm a result of diagnosis progressed up to the present at any time if necessary during the diagnosis and confirm a connected list.

Seventh, the service system can confirm a problem related with a user by directly facing a URL that causes a problem in a user's browser, arguments (i.e., arguments that cause a problem) contained in the URL, and a type of problem.

Eighth, the service system can confirm an external link section when analyzing a web page and easily detect an external domain, if present, which distributes a malicious code in the web service.

Ninth, the service system can confirm a service diagnosis item selected by the user online, an item for confirming the procedure of progress in real-time, and a diagnosis result online, and even confirm a problem and a solution to the problem.

### BRIEF DESCRIPTION OF THE DRAWINGS

FIG. 1 is a view showing a service system for diagnosing vulnerability of a web service in real-time and providing information on a result thereof according to an embodiment of the present invention.

FIG. 2 is a view showing a service process for diagnosing vulnerability of a web service in real-time and providing information on a result thereof according to an embodiment of the present invention.

FIG. 3 is a screen displaying a direct error of a DB as a result of analyzing a result sent from a target system and classifying vulnerability of each DB, before being displayed on a web page according to an embodiment of the present invention.

FIG. 4 is a screen displaying result values intuitively displayed on a user screen when a diagnosis is performed after a user inputs an address according to an embodiment of the present invention.

FIG. 5 is a screen directly confirming a result of diagnosis progressed up to the present through a screen while performing the diagnosis according to an embodiment of the present invention.

FIG. 6 is a screen displaying a diagnosis result shown in a browser page of a user's PC according to an embodiment of the present invention.

FIG. 7 is a screen displaying a diagnosis result shown in a browser page of a user's PC after examining a result for all external URLs linked within a web service according to an embodiment of the present invention.

FIG. 8 is a screen for confirming a service diagnosis item selected by a user online, an item for confirming the procedure of progress in real-time, and a diagnosis result online and directly confirming a problem and a solution to the problem according to an embodiment of the present invention.

FIG. 9 is a screen for manifestly confirming a process of solving overall vulnerability based on a time point of performing the latest diagnosis according to an embodiment of the present invention.

FIG. 10 is a view showing a result of diagnosing a large quantity of domains on a screen according to an embodiment of the present invention.

### EXPLANATION ON SYMBOLS

100: user terminal 200: vulnerability determination system
210: vulnerability scanner 220: web page analysis unit
230: URL link extraction unit 240: diagnosis result transfer unit
250: vulnerability database 260: vulnerability solution link unit
300: target system 310: web page
320: DB server

### BEST MODE FOR CARRYING OUT THE INVENTION

Reference will be now made in detail to preferred embodiments of the present invention with reference to the attached drawings. In the following description, the detailed description on known function and constructions unnecessarily obscuring the subject matter of the present invention will be avoided hereinafter. Also, the terms used herein are defined in consideration of the function of the present invention, which may vary according to an intention of a user or an operator or according to custom. Thus, definition of such terms should be made based on content throughout the specification disclosing a service process for diagnosing vulnerability of a web service in real-time and providing information on a result thereof according to the present invention.

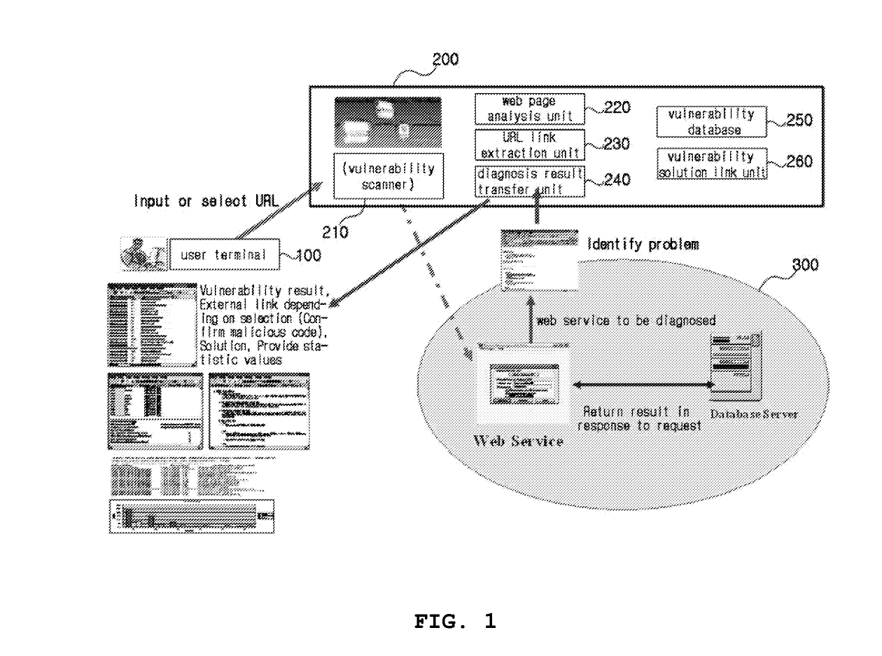

FIG. 1 is a view showing a service system for diagnosing vulnerability of a web service in real-time and providing information on a result thereof according to an embodiment of the present invention.

The service system for diagnosing vulnerability of a web service in real-time and providing information on a result thereof includes a user terminal 100, a vulnerability determination system 200, a vulnerability scanner 210, a web page analysis unit 220, a URL link extraction unit 230, a diagnosis result transfer unit 240, a vulnerability database 250, a vulnerability solution link unit 260, a target system 300, a web page 310, and a DB server 320.

As shown in FIG. 1, the service system for diagnosing vulnerability of a web service in real-time and providing information on a result thereof includes: a user terminal 100 having a function of allowing a user to initially input or select a URL or a start page of a web service managed by the user through the user terminal and diagnose the web service through a vulnerability determination system, the user terminal configured to receive information on a result of vulnerability, information on a solution to a problem of an external link where a malicious code is identified, and statistical information from the vulnerability determination system; the vulnerability determination system 200 configured to receive the URL or the start page of the web service from the user terminal, extract a URL link, scan a web page, transmit the scanned web page to a target system, receive an identified problem from the target system, analyze the web page, store an analysis result in a vulnerability database, and transmitting information on a diagnosis result and information on a solution to the problem to the user terminal; and the target system 300 configured to read and diagnose the web page received from the vulnerability determination system, and identify and transmit vulnerability and link problems to the vulnerability determination system.

The functions of the technical means configuring the service system for diagnosing vulnerability of a web service in real-time and providing information on a result thereof of the present invention are described below.

A user terminal 100 has a function of allowing a user to initially input or select a URL or a start page of a web service managed by the user through the user terminal 100 and diagnose the web service through a vulnerability determination system 200, and receives information on a result of vulnerability, information on a solution to a problem of an external link where a malicious code is identified, and statistical information from the vulnerability determination system 200.

The vulnerability determination system 200 receives the URL or the start page of the web service from the user terminal 100, extracts a URL link, scans a web page, transmits the scanned web page to a target system 300, receives an identified problem from the target system 300, analyzes the web page, stores an analysis result in a vulnerability database 250, and transmits information on a diagnosis result and information on a solution to the problem to the user terminal.

Here, the vulnerability determination system 200 includes a vulnerability scanner 210 for receiving a URL or a start page of a web service from the user terminal 100, scanning the URL or the start page of the web service, and transmitting the scanned URL or start page to the target system 300; a URL link extraction unit 230 for receiving a URL of a web service from the user terminal 100 and extracting a URL link; a web page analysis unit 220 for receiving a diagnosis result from the target system 300 and analyzing the diagnosis result after the vulnerability scanner 210 transmits the web page to the target system 300; the vulnerability database 250 for storing a vulnerability problem from the result analyzed by the web page analysis unit 220; a vulnerability solution link unit 260 for storing information on a solution to the vulnerability problem and solving the vulnerability appropriately if the problem occurs; and a diagnosis result transfer unit 240 for transmitting the vulnerability problem and the solution information received from the target system 300 to the user terminal 100.

The URL link extraction unit 230 confirms a link. First, the link is confirmed by examining a URL link section used by HTML, i.e., arguments such as src, img, href, li, option, and form. Second, an address of a character string having an extension used by a web service in the source of a web page is determined, i.e., examining http or https with characters. Third, after reading all the values of characters surrounded by quotation marks “and ’, values of a character string having an address format of a web page are read, and whether or not the character string is an address is determined. There is a section for identifying a link part connected to another internal or external page using the three methods simultaneously, and the three methods can be applied to an xml file, a js file or a swf (flash) file that can be regarded as a separate file, but not a web page, in the same manner.

A file is downloaded and connected to the web page analysis unit in real-time in order to analyze a flash file in the web page analysis unit 220. The web page analysis unit confirms whether or not the file is a flash file, analyzes the internal file structure, identifies a section written in an Action Script, identifies an internal or external link existing in the corresponding section, and stores the link as an address to visit and analyze in next turn.

The target system 300 reads and diagnoses the web page received from the vulnerability determination system 200, identifies vulnerability and link problems, and transmits the identified vulnerability and link problems to the vulnerability determination system 200. The target system 300 includes an argument separation unit configured to confirm whether or not there is a fundamental problem in vulnerability that can be analyzed in real-time in order to promptly diagnose the vulnerability existing in a web page, a transfer unit configured to input additional characters in each argument and transferring the argument to a web service that is to be diagnosed, and a determination unit configured to determine a result returned from the web service. Since the object is promptly diagnosing the web page through a web service, a problem related to Injection for confirming a communication result between a web service and a database server and pointing out problems and vulnerability of XSS which inserts an external link into a result of a web page are intensively diagnosed as basically diagnosed problems. The Injection vulnerability is discovered in most of databases, and when a query statement (SQL) transferred to a database in a web service is manipulated by an external input, the query statement is transferred to the web page even in a situation where a normal service result value cannot be transmitted.

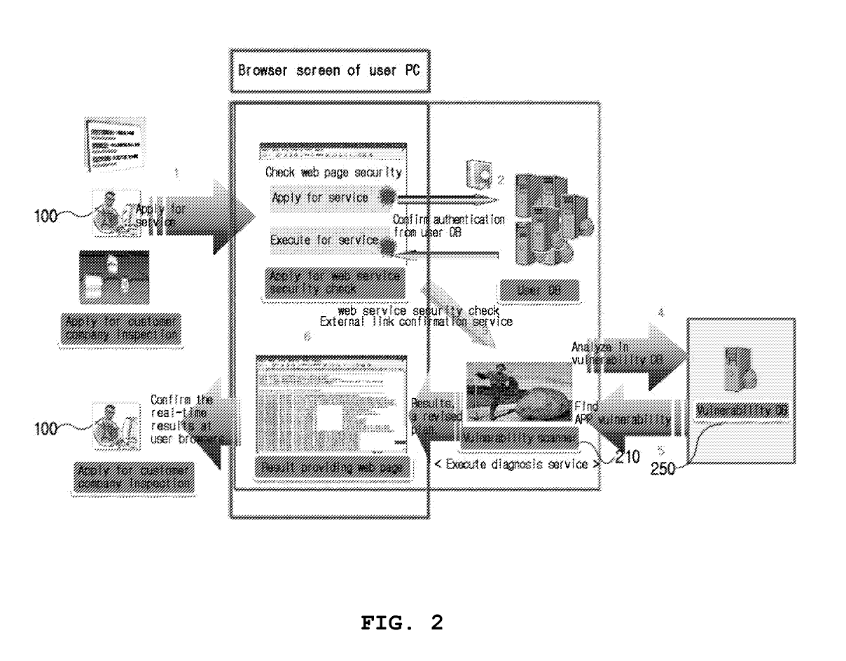

FIG. 2 is a view showing a service process for diagnosing vulnerability of a web service in real-time and providing information on a result thereof according to an embodiment of the present invention.

As shown in FIG. 2, a user inputs a URL or a web page of a web service through the user terminal 100. A service for checking security of a web page is applied for through a browser screen of the user terminal 100, and the user inputs or selects an address if the user is normally authenticated. Next, in order to check security of the web page on browser screen of the user terminal 100, the user is authenticated from a user DB, receives a result of the authentication, and executes the service. Next, in order to receive a service of checking security of a web service and confirming an external link, information on the web service is transmitted to the vulnerability scanner 210 of the vulnerability determination system 200. Next, when the vulnerability scanner 210 requests analysis of vulnerability from the vulnerability database 250, if, for example, APP vulnerability is identified, information on the vulnerability is transmitted to the vulnerability scanner 210 of the vulnerability determination system 200, and the vulnerability scanner 210 performed a diagnosis service. Next, the vulnerability scanner 210 displays a result of the vulnerability and a method of modifying the browser screen of the user terminal 100 in the form of a web page. Next, the user confirms a result in real-time through the browser screen of the user terminal 100.

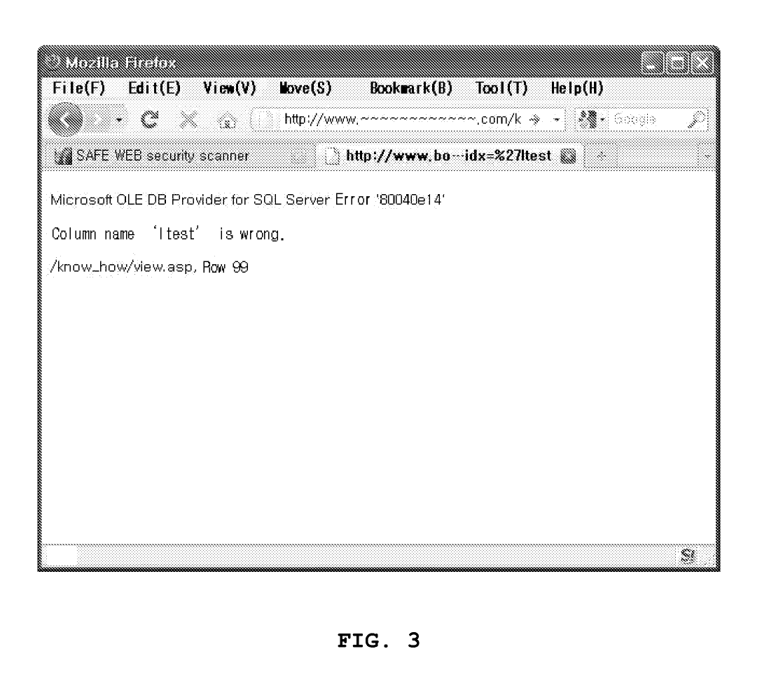

FIG. 3 is a screen displaying a direct error of a DB as a result of analyzing a result sent from a target system and classifying vulnerability of each DB, before being expressed as a web page according to an embodiment of the present invention.

As shown in FIG. 3, it can be confirmed that a direct error of a DB is transferred to the screen. Before being displayed on a web page, a result sent from the target system is analyzed, and a result of classifying the vulnerability by the DB is displayed. The result shows that SQL Injection is possible for MS SQL. Currently supported DBs are MS SQL, Oracle, Mysql and PostfreSQL, and problems can be diagnosed for more than 90% of DBs in the world. In addition, a different result may be obtained depending on a web page development language, and problems can be identified for most of web service development languages, such as Java, PHP, ASP, dotNet, Pl, CGI, and the like.

A section which contains data on the vulnerability of each database in a program in the form of data and confirms existence of a problem by comparing the contained data and a result sent from a web service is the core of the operation, and problems occurring due to difference of development languages can be identified by operating with a suspect result determination routine stored in the program.

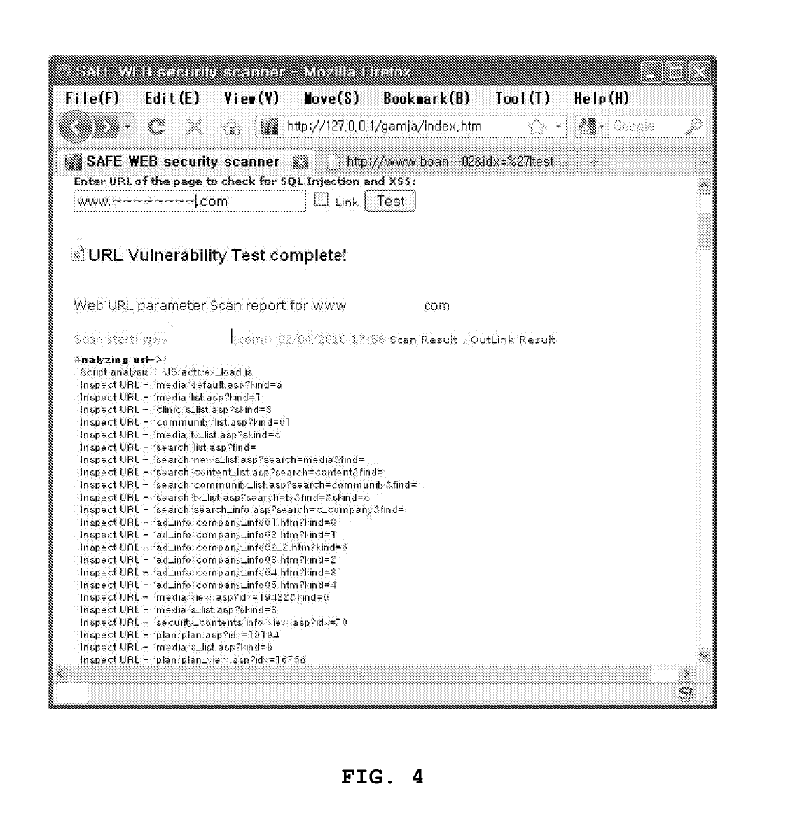

FIG. 4 is a screen displaying result values intuitively displayed on a user screen when a diagnosis is performed after a user inputs an address according to an embodiment of the present invention.

As shown in FIG. 4, when a user inputs an address and performs a diagnosis, result values are intuitively displayed on a user screen. Although a different result is displayed for each browser, it is already confirmed that the entire results can be seen. There is a section where the Script is analyzed, and the procedure of examining each link can be confirmed in real-time by conducting analysis on the link based on a portion where an index page is analyzed. A result of diagnosis progressed up to the present can be confirmed at any time if necessary during the diagnosis, and a connected list can also be confirmed.

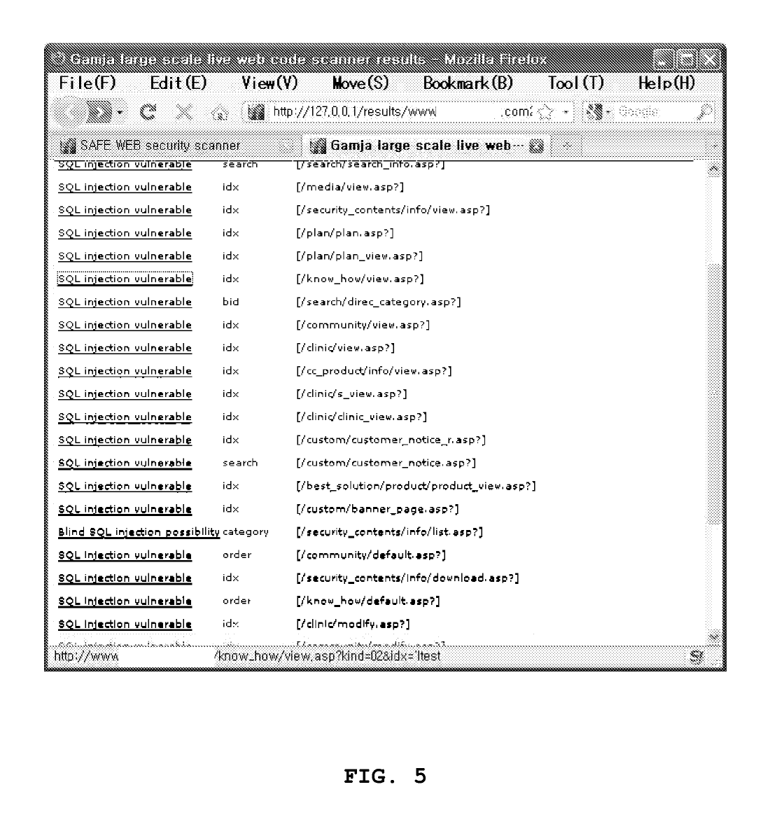

FIG. 5 is a screen directly confirming a result of diagnosis progressed up to the present through a screen while performing the diagnosis according to an embodiment of the present invention.

As shown in FIG. 5, a result of diagnosis progressed up to the present can be confirmed directly through the screen during the diagnosis, and the user may directly confirm the result from the user's browser. A problem of the user can be confirmed by directly facing a URL that causes a problem, arguments (i.e., arguments that cause a problem) contained in the URL, and a type of problem. In addition, statistical data are provided after the diagnosis is completed, and there is a section capable of confirming whether or not a service is currently improved by comparing previous records. In addition, it is possible to manifestly confirm the state of overall vulnerability.

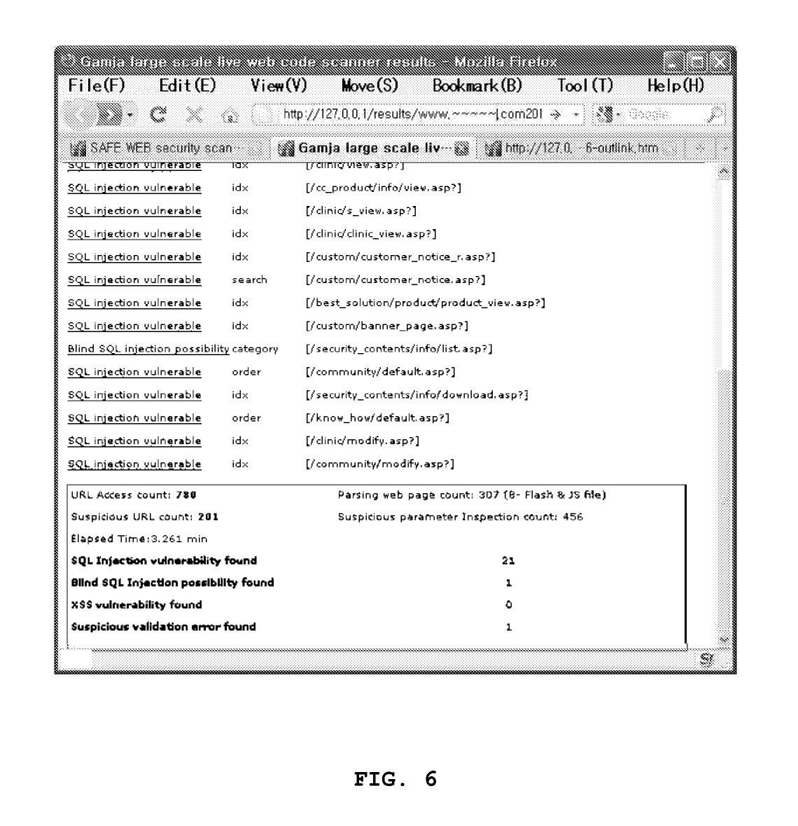

FIG. 6 is a screen displaying a diagnosis result shown in a browser page of a user's PC according to an embodiment of the present invention.

As shown in FIG. 6, statistical values are divided into statistics on one time diagnosis and statistics on the case of existence of previous records. The statistics on one time diagnosis include statistics on entire pages, statistics on files (Flash or JS) other than analyzed html files, pages tried to be analyzed (a page on which analysis is not tried is a portion classified as an argument that does not have a URL configuration and excluded by an analysis engine), a suspicious URL count (classifies a type of pages which issue a query to a DB with arguments), and a result routine of each vulnerability. The vulnerability is classified depending on the risk and is set to respond depending on the degree of risk. The user may confirm the problem of existence of suspicious points other than the predefined vulnerability through an item of ‘suspicious validation error’. The result shown in a browser page of a user's PC as a diagnosis result is configured in a structure capable of directly confirming a problem when the user clicks a link. An external link portion can be confirmed when a page is analyzed, and if there is an external domain which distributes a malicious code in a web service, it can be easily identified.

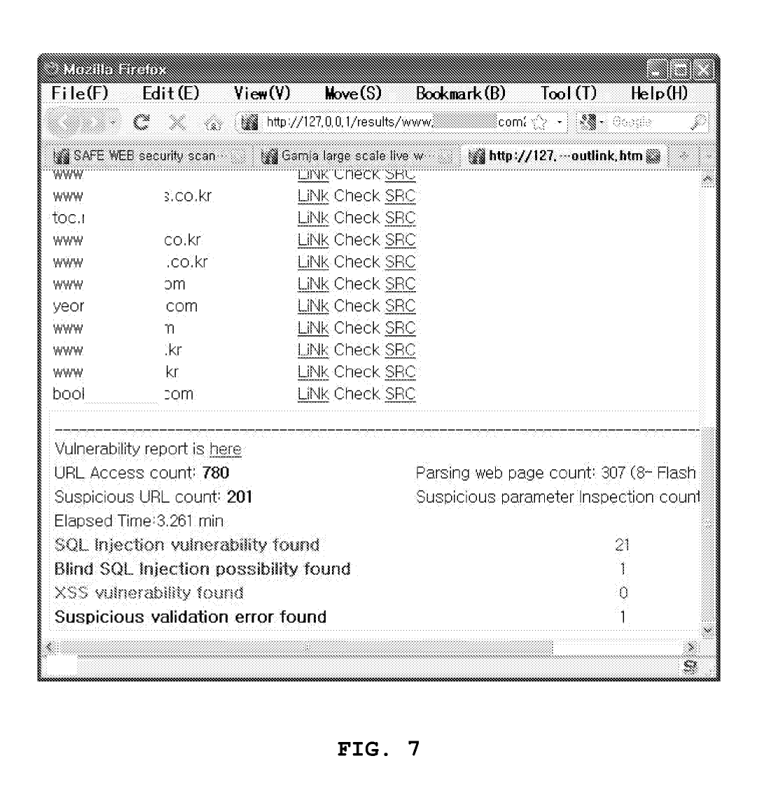

FIG. 7 is a screen displaying a diagnosis result shown in a browser page of a user's PC after examining a result for all external URLs linked within a web service according to an embodiment of the present invention.

As shown in FIG. 7, a result is examined for all external URLs linked within a web service, and it displays a page where the links are found. Therefore, if a malicious code is distributed by an external URL, it can be easily found.

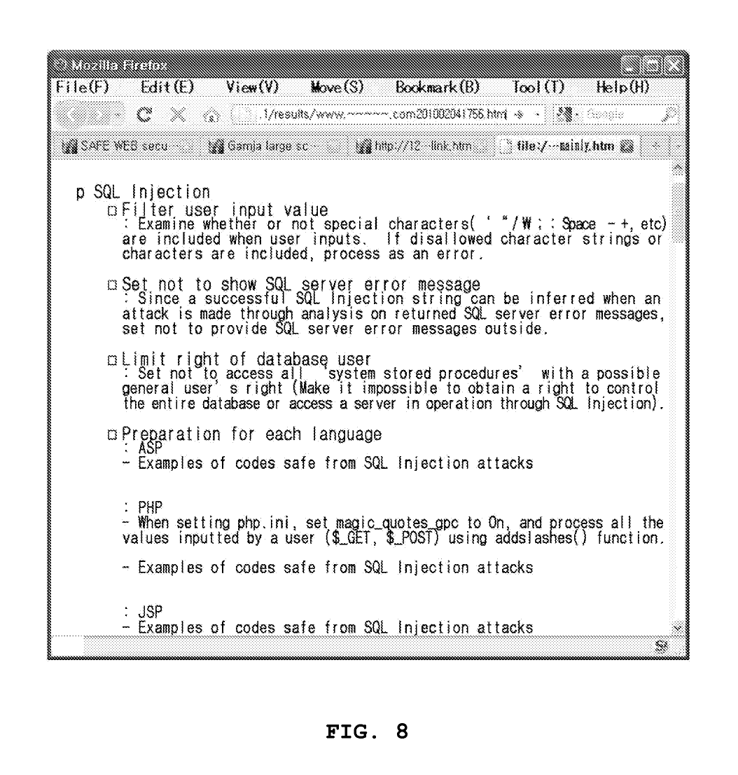

FIG. 8 is a screen for confirming an item for service diagnosis selected by a user online, an item for confirming the procedure of progress in real-time, and a diagnosis result online and directly confirming a problem and a solution to the problem according to an embodiment of the present invention.

As shown in FIG. 8, an item for service diagnosis selected by a user online, an item for confirming the procedure of progress in real-time, and a diagnosis result can be confirmed online. Problems can be confirmed, and items for directly confirming even the solutions of the problems are also selected. In addition, there are items capable of intuitively confirming positions where malicious codes are distributed from outside and domains distributing the malicious codes by checking all the external links without analyzing all the source codes, and there are statistical value items for the results.

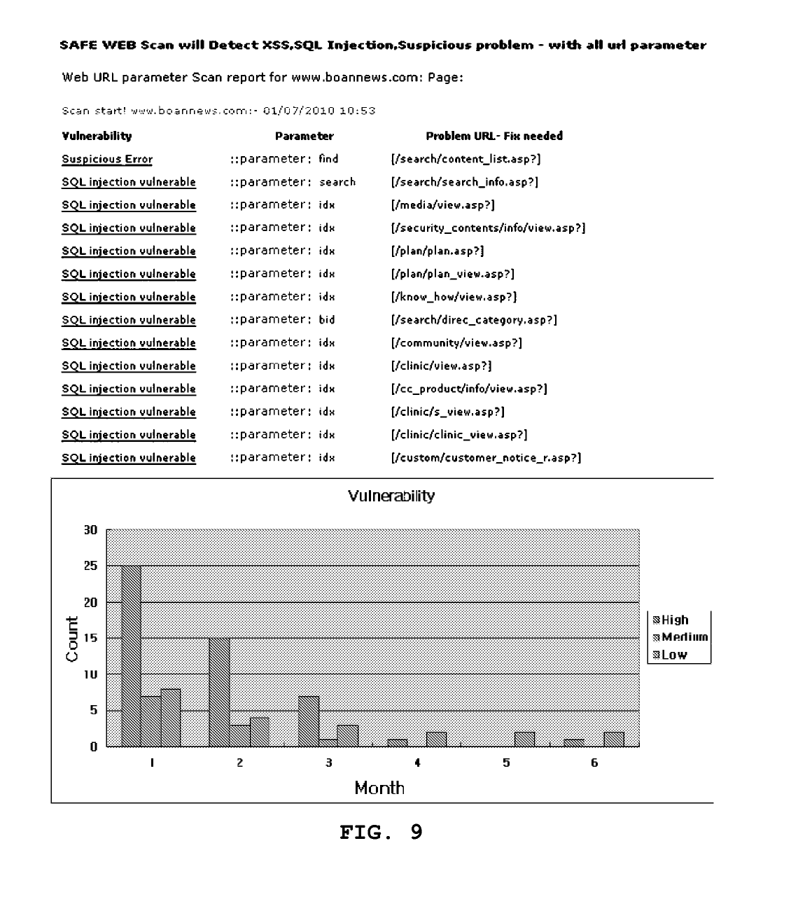

FIG. 9 is a screen for manifestly confirming a process of solving overall vulnerability based on a time point of performing the latest diagnosis according to an embodiment of the present invention.

As shown in FIG. 9, the statistics section is configured so as to manifestly confirm the process of solving overall vulnerability based on a time point performing the latest diagnosis, and thus the current state of progress for solving the vulnerability problem can be confirmed. A vulnerability discovery counter is created and charted for each count referring to a previous diagnosis execution record depending on the vulnerability categorized into high, medium and low, and thus improvements and changes of the real service can be confirmed.

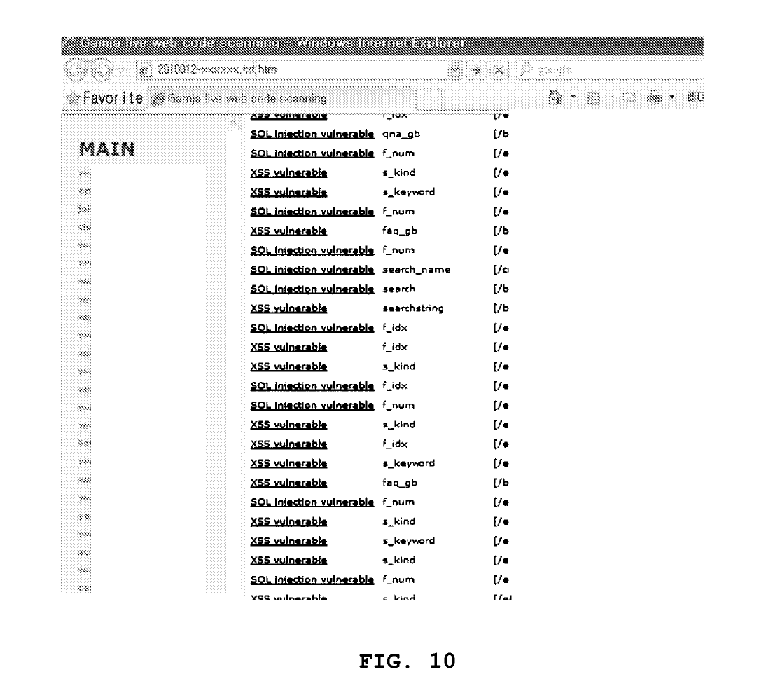

FIG. 10 is a view showing a result of diagnosing a large quantity of domains on a screen according to an embodiment of the present invention.

As shown in FIG. 10, a service capable of receiving a user input and performing a batch diagnosis for a large-scaled domain can also be specified as a separate item. If a certain time is specified or a diagnosis is performed in domains registered by a user, vulnerability of all the registered domains can be confirmed on a screen. Therefore, a batch diagnosis is performed for one hundred or more sub-domains, and vulnerable items are displayed in a user's browser of a screen.

Therefore, the inventive service system can receive an input of a user's web service address through the web service, automatically visit a corresponding web service to perform a real-time analysis on a web page and check if the web page has vulnerability of interest, and transmit information on the checked result to a user PC. The service system can also provide an intuitive service by displaying discovery and progress of the vulnerability, and an external URL linked in the web page on the user screen. In addition, the service system can determine a possibility of leakage of information contained in the URL by checking whether or not a special symbol or reserved word (e.g., system command) among arguments is filtered by analyzing the web page, can analyze a result sent from a target system and display a result of classifying vulnerability of each DB before being displayed on the web page, and can confirm existence of a problem by storing data on the vulnerability of each DB in a program in the form of data and comparing the data with the result received from the web service. A user may confirm the process of finding a link of a web page and confirming a problem and the process of performing an analysis by himself or herself online.

### INDUSTRIAL APPLICABILITY

As described above, the present invention can be applied in providing a service which receives an input of a user's web service address through the web service, automatically visits a corresponding web service to perform a real-time analysis on a web page and checks if the web page has vulnerability of interest, and transmits information on the checked result to a user PC. In addition, since the present invention can be applied in a field that prevents various types of attacks on web applications, it is an industrially applicable invention.

While the present invention has been described in connection with the exemplary embodiments illustrated in the drawings, they are merely illustrative embodiments, and the invention is not limited to these embodiments. It is to be understood that various equivalent modifications and variations of the embodiments can be made by a person having an ordinary skill in the art without departing from the spirit and scope of the present invention. Therefore, the true technical scope of the present invention should be defined by the technical spirit of the appended claims.

What is claimed is:

1. A service system for diagnosing vulnerability of a web service in real-time and providing information on a result thereof, the system comprising:
a user terminal having a function of allowing a user to initially input or select a URL or a start page of a web service managed by the user through the user terminal and diagnose the web service through a vulnerability determination system, the user terminal configured to receive information on a result of vulnerability, information on a solution to a problem of an external link where a malicious code is identified, and statistical information from the vulnerability determination system;
the vulnerability determination system configured to receive the URL or the start page of the web service from the user terminal, extract a URL link, scan a web page, transmit the scanned web page to a target system, receive an identified problem from the target system, analyze the web page, store an analysis result in a vulnerability database, and transmitting information on a diagnosis result and information on a solution to the problem to the user terminal; and
the target system configured to read and diagnose the web page received from the vulnerability determination system, and identify and transmit vulnerability and link problems to the vulnerability determination system.

2. The service system according to claim 1, wherein the vulnerability determination system comprises:
a vulnerability scanner configured to receive the URL or the start page of the web service from the user terminal, scan the URL or the start page of the web service and transmit the scanned URL or start page to the target system;
a URL link extraction unit configured to receive the URL of the web service from the user terminal and extract the URL link;
a web page analysis unit configured to receive a diagnosis result from the target system and analyze the diagnosis result after the vulnerability scanner transmits the web page to the target system;
a vulnerability database configured to store a vulnerability problem from the result analyzed by the web page analysis unit;
a vulnerability solution link unit configured to store information on a solution to the vulnerability problem and solve the vulnerability appropriately if the problem occurs; and
a diagnosis result transfer unit configured to transmit the vulnerability problem and the solution information received from the target system to the user terminal.

3. The service system according to claim 2, wherein the URL link extraction unit confirms a link by examining a URL link section used by HTML, i.e., arguments such as src, img, href, li, option, and form; determining an address of a character string having an extension used by a web service in the source of a web page, i.e., examining http or https with characters; or reading all the values of characters surrounded by quotation marks “and ’, reading values of character strings having an address format of a web page, and determining whether or not the character string is an address.

4. The service system according to claim 2, wherein the methods in which the URL link extraction unit confirms a link are applied to an xml file, a js file or a swf (flash) file that can be regarded as a separate file, but not a web page, in the same manner.

5. The service system according to claim 2, wherein a file is downloaded and connected to the web page analysis unit in real-time in order to analyze a flash file in the web page analysis unit, and the web page analysis unit confirms whether or not the file is a flash file, analyzes the internal file structure, identifies a section written in an Action Script, identifies an internal or external link existing in the corresponding section, and stores the link as an address to visit and analyze in next turn.

6. The service system according to claim 1, wherein the target system comprises an argument separation unit configured to confirm whether or not there is a fundamental problem in vulnerability that can be analyzed in real-time in order to promptly diagnose the vulnerability existing in a web page, a transfer unit configured to input additional characters in each argument and transferring the argument to a web service that is to be diagnosed, and a determination unit configured to determine a result returned from the web service.
